(19) United States
(12) Patent Application Publication
(10) Pub. No.: US 2025/0214560 A1
(43) Pub. Date: Jul. 3, 2025

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventor: Fumio Ogawa, Toyota-shi (JP)

(73) Assignee: TOYOTA JIDOSHA KABUSHIKI KAISHA, Toyota-shi (JP)

(21) Appl. No.: 18/985,312

(22) Filed: Dec. 18, 2024

(30) Foreign Application Priority Data
Dec. 27, 2023 (JP) 2023-220858

(51) Int. Cl. B60W 10/30

(52) U.S. Cl. CPC B60W 10/30; B60W 2556/45

(57) ABSTRACT

An information processing apparatus controls a vehicle having a communication function related to remote operation that is configured to be switched to off mode when a first period of time elapses after an internal combustion engine has stopped operating. The information processing apparatus has a controller configured to execute an auto-start process. The auto-start process is the process of sending a start command for causing the internal combustion engine to operate for a specified period of time when a second period of time that is shorter than the first period of time elapses after the internal combustion engine has stopped operating.

### CROSS REFERENCE TO THE RELATED APPLICATION

This application claims the benefit of Japanese Patent Application No. 2023-220858, filed on Dec. 27, 2023, which is hereby incorporated by reference herein in its entirety.

### BACKGROUND

### Technical Field

The present disclosure relates to an information processing apparatus and an information processing method.

### Description of the Related Art

There is the well-known technology for remote control of air conditioning systems in vehicles (for example, see Patent Literature 1 in the citation list below).

### CITATION LIST

### Patent Literature

Patent Literature 1: Japanese Patent Application Laid-Open No. 2009-120022

### SUMMARY

An object of the present disclosure is to provide a technology that can improve user convenience in remotely controlling vehicles.

In one aspect of the present disclosure, there is provided an information processing apparatus for controlling a vehicle having a communication function related to remote operation that is switched to off mode in response to a first period of time elapses after an internal combustion engine has stopped operating. The information processing apparatus may comprise a controller including at least one processor configured to execute an auto-start process, the auto-start process being the process of sending a start command for causing the internal combustion engine to operate for a specified period of time in response to a second period of time that is shorter than the first period of time elapses after the internal combustion engine has stopped operating.

In another aspect of the present disclosure, there is provided an information processing method for controlling a vehicle having a communication function related to remote operation that is switched to off mode in response to a first period of time elapses after an internal combustion engine has stopped operating. The information processing method may comprise executing an auto-start process by a computer. The auto start process is the process of sending a start command for causing the internal combustion engine to operate for a specified period of time in response to a second period of time that is shorter than the first period of time elapses after the internal combustion engine has stopped operating.

In another aspect of the present disclosure, there is provided a program configured to cause a computer to implement the above information processing method or a non-transitory storage medium that stores such a program in a computer-readable manner.

According to the present disclosure, there is provided a technology that can improve user convenience in remotely controlling vehicles.

### BRIEF DESCRIPTION OF THE DRAWINGS

FIG. 1 is a diagram illustrating the general configuration of a system according to an embodiment.

FIG. 2 is a diagram schematically illustrating an example of the hardware configurations of a vehicle, a user's terminal, and a server included in the system according to the embodiment.

FIG. 3 schematically illustrates an example of a menu screen for remote operations according to the embodiment.

FIG. 4 schematically illustrates an example of an operation screen for an auto-start process according to the embodiment.

FIG. 5 is a diagram schematically illustrating an example of a request signal according to the embodiment.

FIG. 6 schematically illustrates an example of vehicle data according to the embodiment.

FIG. 7 is a block diagram illustrating an example of the software configuration of the server according to the embodiment.

FIG. 8 is a diagram schematically illustrating an example of a remote air conditioning command signal according to the embodiment.

FIG. 9 is a flow chart of an example of a processing routine that is performed in the server triggered by the reception of a request signal according to the embodiment.

FIG. 10 is a flow chart of an example of a processing routine that is performed in the server at regular intervals according to the embodiment.

FIG. 11 schematically illustrates an example of an operation screen for an auto-start process according to a modification.

FIG. 12 is a diagram schematically illustrating an example of a request signal according to the modification.

FIG. 13 schematically illustrates an example of vehicle data according to the modification.

FIG. 14 is a flow chart of an example of a processing routine that is performed in the server at regular intervals according to the modification.

### DESCRIPTION OF THE EMBODIMENTS

Services that allow users to remotely control in-vehicle equipment, such as air conditioning systems and door lock actuators, in parked vehicles with internal combustion engines via smartphones and other devices have been becoming more widespread. Such services will also be referred to as remote services hereinafter. Examples of the vehicles with internal combustion engines include internal combustion engine cars, HEVs, and PHEVs. The vehicle for which remote services are provided is equipped with a communication device, such as a DCM (Data Communication Module), to receive signals related to remote operations. Such a communication device operates using a battery (secondary battery) as the power source. The battery is charged by the electrical power produced while the internal combustion engine is in operation. Therefore, if the communication device remains in standby mode (i.e. the mode in which it can receive signals related to remote operations) for an extended period of time while the vehicle is parked (in other words, while the internal combustion engine is not in operation), the remaining battery capacity may eventually become too low, potentially affecting the operation of the communication device.

One solution to the above problem that we can think of is to switch the mode of the communication device from the standby mode to off mode (i.e. the mode in which it cannot receive signals related to remote operations) in response to a specified period of time (first period of time) elapses after the internal combustion engine has stopped operating. However, this solution can prevent the communication device from receiving signals related to remote operations when the user tries to use the remote service. This may affect the convenience of the user of the remote service.

To address the above problem, the information processing apparatus according to the present disclosure is configured to control the vehicle such that the internal combustion engine is started before the communication function of the vehicle is switched to off mode after the internal combustion engine has stopped operating. The information processing apparatus according to the present disclosure has a controller that is configured to execute the process (auto-start process) of sending a command (start command) for causing the internal combustion engine to operate for a specified period of time in response to a second period of time that is shorter than the first period of time elapses after the internal combustion engine has stopped operating.

The vehicle controlled by the information processing apparatus according to the present disclosure is a vehicle that has a communication function related to remote operations that is switched to off mode in response to the first period of time elapses after the internal combustion engine has stopped operating. The information processing apparatus according to the present disclosure is a computer that performs processing related to remote operations of the vehicle. For example, the information processing apparatus according to the present disclosure may be a server that is connected with the vehicle through a network. In a mode, the specified period of time may be a period of time that is needed to charge a battery provided in the vehicle to increase its remaining capacity, such as SoC (State of Charge), equal to or greater than threshold. The battery may be a battery (secondary battery) that supplies electrical power for the communication function of the vehicle to operate and is charged using the electrical power produced while the internal combustion engine is in operation. The start command may be a command relating to a remote operation that includes the starting of the internal combustion engine among the remote operations that the vehicle can receive. For example, the start command may be a command for performing remote air conditioning. The remote air conditioning is the operation that is performed while the vehicle is parked (in other words, while the power switch or ignition switch is off) to cause the internal combustion engine and the air conditioning system to operate by remote control. Therefore, the auto-start process can be applied to any vehicle for which the remote air conditioning can be performed.

According to the present disclosure, the information processing apparatus sends the start command to the vehicle before the communication function of the vehicle is switched to the off mode after the internal combustion engine has stopped operating. Therefore, the vehicle can receive the start command. Then, the vehicle can cause the internal combustion engine to operate for the specified period of time according to the start command it has received. Operating the internal combustion engine for the specified period of time can reset the start point of the first period of time and charge the battery to extend the period of time over which the communication function of the vehicle can remain in the standby mode.

In the auto-start process according to the present disclosure, the controller can repeatedly send the start command to the vehicle. In other words, even after the internal combustion engine has operated for the specified period of time according to the start command, the controller can send the start command again to the vehicle in response to the second period of time elapses after the internal combustion engine has stopped operating. This allows the communication function of the vehicle to remain in the standby mode for an extended period of time. This is effective in preventing situations where the communication function of the vehicle is unable to receive signals related to remote operations when the user of the vehicle tries to use a remote service.

In the auto-start process according to the present disclosure, the number of times of sending the start command may be limited to a specified number or less. Then, executing the auto-start process according to the present disclosure may include determining whether the number of previous instances of sending the start command is less than a specified number of times in response to the second period of time elapses after the internal combustion engine has stopped operating, and sending the start command if it is determined that the number of previous instances is less than the specified number of times. This can limit the number of times of sending the start command in the auto-start process to the specified number of times or less. In other words, this can limit the number of times of starting the internal combustion engine through the auto-start process to the specified number of times or less. This is effective in preventing the fuel of the internal combustion engine from being consumed too much by performing the auto-start process.

The time to perform the auto-start process, the second period of time, and the specified number of times may be arbitrarily specified by the user. In that case, the controller of the information processing apparatus according to the present disclosure may be configured to execute the processing of receiving a request signal requesting the execution of the auto-start process and containing information specifying the second period of time and the specified number of times from a first terminal used by the user of the vehicle, and starting the execution of the auto-start process according to the second period of time and the specified number of times specified by the request signal. This allows the user to specify the time to perform the auto-start process, the second period of time, and the specified number of times taking into consideration the period through which the vehicle will not be in use and the amount of fuel remaining in the vehicle. In consequence, the user can perform the auto-start process in a manner suitable for the user's way of using the vehicle.

A time limit may be set for the auto-start process according to the present disclosure. Specifically, executing the auto-start process according to the present disclosure may include determining whether a time limit for the auto-start process has expired in response to the second period of time elapses after the internal combustion engine has stopped operating, and if it is determined that the time limit has not expired, sending the start command to the vehicle. This limits the execution of the auto-start process within the time limit. This is effective in preventing the fuel of the internal combustion engine from being consumed too much by performing the auto-start process.

The time to perform the auto-start process, the second period of time, and the time limit may be arbitrarily specified by the user. In that case, the controller of the information processing apparatus according to the present disclosure may be configured to execute the processing of receiving a request signal requesting the execution of the auto-start process and containing information specifying the second period of time and the time limit from a first terminal used by the user of the vehicle, and starting the execution of the auto-start process according to the second period of time and the time limit specified by the request signal. This allows the user to specify the time to perform the auto-start process, the second period of time, and the time limit taking into consideration the period through which the vehicle will not be in use and the amount of fuel remaining in the vehicle. In consequence, the user can perform the auto-start process in a manner suitable for the user's way of using the vehicle.

In the mode in which the time to perform the auto-start process, the second period of time, and the specified number of times or the time limit are arbitrarily specified by the user, the controller may be configured to further execute the processing of sending a notification indicating that the execution of the auto-start process is about to start to a second terminal used by a joint user of the vehicle in response to the request signal is received. The joint user refers to a user who jointly owns or uses the vehicle 10 with the user (e.g. a member of the user's family). This allows the joint user to be aware that the auto-start process starts to be executed.

### EMBODIMENT

In the following, an embodiment of the technology disclosed herein will be described with reference to the drawings. The features of the following embodiment are illustrative, and the embodiment described here is merely an example in every aspect. Various improvements and modifications may be made without departing from the scope of the present disclosure. When implementing the disclosed technology, suitable concrete features may be adopted according to the mode of implementation. While data related to the embodiment is described in natural language, it is specified in further detail by computer-recognizable artificial language, commands, parameters, and machine language, and/or the like.

### (Outline of System)

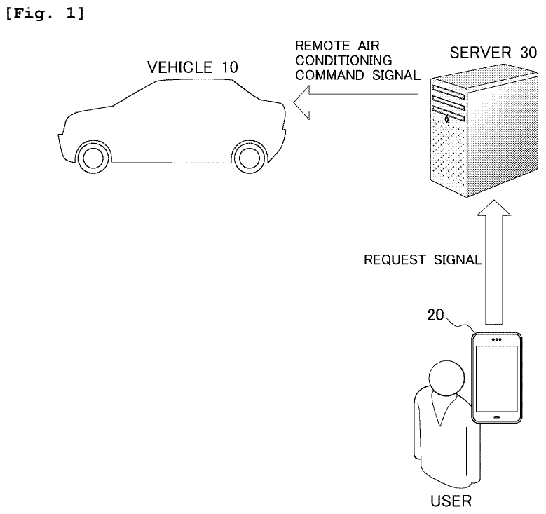

FIG. 1 is a diagram illustrating an example of a system to which the technology disclosed herein is applied. The system according to the embodiment includes a vehicle 10, a user's terminal 20, and a server 30. While FIG. 1 shows only one vehicle 10 and only one user's terminal 20, the system can include a plurality of vehicles 10 and a plurality of user's terminals 20 that are managed by the server 30.

The vehicle 10 is an automobile with an internal combustion engine 130, which will be described in detail later. In a mode, the vehicle 10 may be an automobile powered only by an internal combustion engine. The vehicle 10 is not limited to an automobile powered only by an internal combustion engine, but it may be an HEV or a PHEV with an internal combustion engine. The vehicle 10 is equipped with a communication device 100, which will be described in detail later, to communicate with the server 30 through it. The vehicle 10 in the system according to the embodiment is configured to receive operation command signals sent from the server 30 through the communication device 100. The operation command signals are signals containing commands related to remote operation. Examples of the commands related to remote operations include a command to perform remote air conditioning and a command to perform remote door locking. The remote air conditioning refers to the operation of remotely starting the internal combustion engine 130 and causing the air conditioning system 120 and a generator 140 to operate, which will be described later. Remote door locking refers to the operation of remotely locking or unlocking the doors of the vehicle 10. The vehicle 10 is configured to cause devices provided in it to operate according to the operation command signals received from the server 30.

The communication device 100 of the vehicle 10 in the system according to the embodiment is configured to be powered by a battery 105 as the power source. The battery 105 will be descried in detail later. The battery 105 is a secondary battery that is charged by the electrical power produced by the generator 140, which will be described in detail later, while the internal combustion engine 130 is in operation. Since the communication device 100 of the vehicle 10 in the system according to the embodiment is powered by the battery 105 that is charged in the manner described above, the communication device 100 is configured to be switched from standby mode to off mode in response to a first period of time elapses after the internal combustion engine 130 has stopped operating. The standby mode is the mode in which the communication device 100 can receive operation command signals sent from the server 30; the off mode is the mode in which the communication device 100 cannot receive operation command signals sent from the server 30. This is because if the communication device 100 remains in the standby mode for a long period of time while the internal combustion engine 130 is not in operation (in other words, while the battery 105 is left uncharged), the remaining capacity of the battery 105 may eventually become too low, potentially affecting the operation of the communication device 100.

The user's terminal 20 is a computer used by the user of the vehicle 10. The user's terminal 20 has the function of receiving remote operations performed by the user and the function of sending remote operation signals containing information related to the received remote operations (e.g. a specified operation of remotely operated in-vehicle equipment) to the server 30. The user's terminal 20 in the system according to the embodiment further has the function of receiving a request to execute an auto-start process that will be described later from the user and the function of sending a request signal containing the request to execute the auto-start process to the server 30. The auto-start process will be described in more detail later.

The server 30 is one or more computers that perform processes related to remote operations of the vehicle 10. Upon receiving a remote operation signal sent from the user's terminal 20, the server 30 sends an operation command signal that is configured to cause the target in-vehicle equipment to operate in the manner specified by the remote operation signal. The server 30 in the system according to the embodiment also has the function of executing the auto-start process upon receiving the request signal sent from the user's terminal 20.

### (Auto-Start Process)

The auto-start process according to the embodiment will now be described. The auto-start process is the process of automatically sending an operation command signal for causing the internal combustion engine 130 to operate for a specified period of time from the server 30 to the vehicle 10 in response to a second period of time elapses after the internal combustion engine 130 has stopped operating. The second period of time is a period of time that is shorter than the first period of time. As described above, the first period of time is the period from when the internal combustion engine 130 stops operating until the communication device 100 is switched to the off mode. According to this embodiment, the second period of time is specified arbitrarily by the user. How the second period of time is specified will be described later.

In the auto-start process according to the embodiment, an operation signal for executing remote air conditioning, which will also be referred to as the “remote air conditioning command signal” hereinafter, is used as the operation command signal for causing the internal combustion engine 130 to operate for a specified period of time. The remote air conditioning command signal specifies a period of time (the specified period of time) over which remote air conditioning is to be performed. In the case where the vehicle 10 is configured to be capable of operating according to a remote operation that starts the internal combustion engine 130 without causing the air conditioning system 120 to operate, an operation command signal for this remote operation may be used.

When the auto-start process is performed in the server 30, the remote air conditioning command signal is sent from the server 30 to the vehicle 10 before the first period of time elapses after the internal combustion engine 130 has stopped operating, in other words, when the second period of time elapses after the internal combustion engine 130 has stopped operating. This means that the remote air conditioning command signal is sent from the server 30 to the vehicle 10 before the communication device 100 is switched from the standby mode to the off mode after the internal combustion engine 130 has stopped operating. Therefore, the vehicle 10 can receive the remote air conditioning command signal. In consequence, the vehicle 10 can perform remote air conditioning according to the remote air conditioning command signal. Specifically, the vehicle 10 starts the internal combustion engine 130 and causes the air conditioning system 120 and the generator 140 to operate. Furthermore, when a specified period of time elapses after the start of the operation of the internal combustion engine 130, the vehicle 10 can stop the internal combustion engine 130 and stop the operation of the air conditioning system 120 and the generator 140.

Performing the remote air conditioning of the vehicle 10 in the manner described above can reset the start point of the first period of time and charge the battery 105 as the power source of the communication device 100. In consequence, the period of time over which the communication device 100 of the vehicle 10 can remain in the standby mode is extended.

In the auto-start process according to the embodiment, the processing of automatically sending the remote air conditioning command signal from the server 30 to the vehicle 10 is executed iteratively. Specifically, after the internal combustion engine has operated for a specified period of time according to the remote air conditioning command signal, the server 30 automatically sends the remote air conditioning command signal to the vehicle 10 again in response to the second period of time elapses after the internal combustion engine has stopped operating. This allows the communication device 100 of the vehicle 10 to remain in the standby mode. This is effective in preventing situations where the communication device 100 is unable to receive signals from the server 30 when the user of the vehicle 10 tries to use a remote service.

If the processing of sending the remote air conditioning command signal from the server 30 to the vehicle 10 is executed iteratively, the remaining amount of fuel (i.e. the amount of fuel remaining in the fuel tank of the vehicle 10) can become too low, potentially affecting the travel of the vehicle 10. To avoid this, in the auto-start process according to the embodiment, the number of times of automatically sending the remote air conditioning command signal from the server 30 to the vehicle 110 is limited to a specified number of times or less. In the system according to the embodiment, this specified number of times is specified arbitrarily by the user of the vehicle 10. How the specified number of times is specified will be described later. Limiting the number of times of automatically sending the remote air conditioning command signal to the specified number of times or less is effective in preventing the remaining amount of fuel from becoming too low due to the execution of the auto-start process.

### (Hardware Configuration of System)

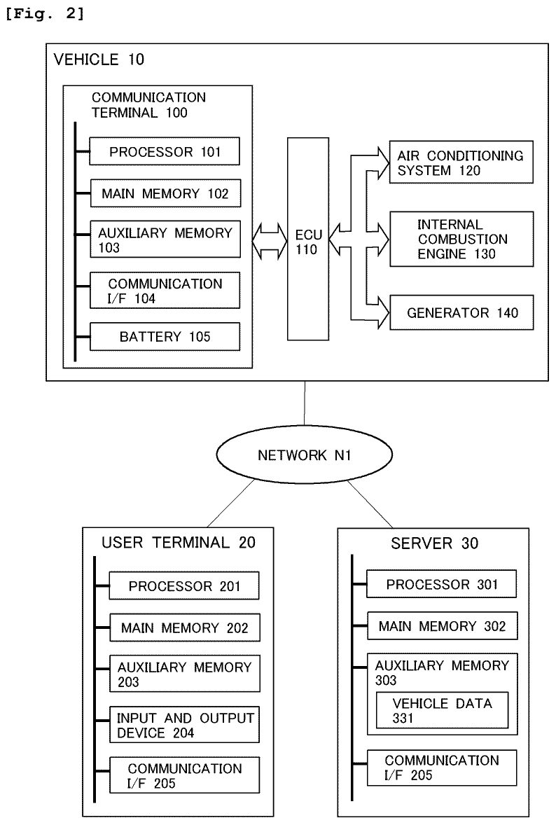

The hardware configurations of the vehicle 10, the user's terminal 20, and the server 30 included in the system according to the embodiment will be described with reference to FIG. 2. FIG. 2 is a diagram schematically illustrating an example of the hardware configurations of the vehicle 10, the user's terminal 20, and the server 30 included in the system according to the embodiment.

### ((Vehicle))

An example hardware configuration of the vehicle 10 will described first. As described above, the vehicle 10 used in the system according to the embodiment is an automobile with an internal combustion engine. As illustrated in FIG. 2, the vehicle 10 has the communication device 100, an ECU (Electronic Control Unit) 110, the air conditioning system 120, the internal combustion engine 130, and the generator 140. The communication device 100, the ECU 110, the air conditioning system 120, the internal combustion engine 130, and the generator 140 are interconnected via an in-vehicle network based on CAN (Controller Area Network), LIN (Local Interconnect Network), FlexRay or other standard.

While FIG. 2 illustrates only the hardware components related to the auto-start process, the vehicle 10 can be provided with other hardware components than those illustrated in FIG. 2. For example, the vehicle 10 may be provided with equipment that can be operated by remote operation, examples of which include a door lock actuator and a power window actuator.

The communication device 100 is a computer provided in the vehicle 10 and capable of communicating with the server 30 through a network N1. The communication device 100 used in the system according to the embodiment is configured to receive operation command signals related to remote operations from the server 30 and to send the received operation command signals to the ECU 110. The operation command signals include an operation command signal related to the auto-start process (i.e. remote air conditioning command signal). As illustrated in FIG. 2, the communication device 100 has a processor 101, a main storage unit 102, an auxiliary storage unit 103, a communication interface 104, and a battery 105. The processor 101, the main storage unit 102, the auxiliary storage unit 103, the communication interface 104, and the battery 105 are interconnected by buses.

The processor 101 is an arithmetic processing unit such as a CPU (Central Processing Unit), a GPU (Graphics Processing Unit), or a DSP (Digital Signal Processor). The processor 101 loads programs stored in the auxiliary storage unit 103 into the main storage unit 102 and execute them to control the communication device 100.

The main storage unit 102 includes semiconductor memories such as a RAM (Random Access Memory) and a ROM (Read Only Memory). The main storage unit 102 provides a storage area into which programs stored in the auxiliary storage unit 103 are loaded and a work area. The main storage unit 102 is also used as a buffer for arithmetic processing by the processor 101.

For example, the auxiliary storage unit 103 is an EPROM (Erasable Programmable ROM) or an HDD (Hard Disk Drive). The auxiliary storage unit 103 can include a removable medium, namely a portable recording medium. Examples of the removable medium include a USB (Universal Serial Bus) memory, and disc media such as CD (Compact Disc) and a DVD (Digital Versatile Disc). The auxiliary storage unit 103 stores various programs and data to be used by the processor 101 when executing the programs.

The programs stored in the auxiliary storage unit 103 include an operating system (OS) and a special-purpose program(s) to cause the processor 101 to execute processing related to remote operations. A portion or the entirety of the information stored in the auxiliary storage unit 103 may be stored in the main storage unit 102 instead. A portion of the information stored in the main storage unit 102 may be stored in the auxiliary storage unit 103 instead.

The communication interface 104 includes an interface for connecting the communication device 100 to the in-vehicle network and an interface for connecting the communication device 100 to the network N1 outside the vehicle 10. According to the embodiment, the communication interface 104 communicates with the ECU 110 through the in-vehicle network. According to the embodiment, the communication interface 104 communicates with the server 30 through the network N1 outside the vehicle 10. For example, the network N1 outside the vehicle 10 is WAN, which is a global public communication network such as the Internet, or other communication network. The communication interface 104 connects the communication device 100 to the network N1 using mobile communications, such as 5G (5th generation) or 6G (6th generation) mobile communications, or wireless communications, such a Wi-Fi (registered trademark).

The battery 105 is a secondary battery, which serves as the power source of the communication device 100. The battery 105 is charged by the electrical power produced by the generator 140 while the internal combustion engine 130 is in operation. Alternatively, the power source of the communication device 100 may be a battery that supplies the electrical power to the electric equipment of the vehicle 10 instead of the battery 105 specifically provided for the communication device as shown in FIG. 2.

When the communication interface 104 of the communication device 100 configured as above receives an operation command signal sent from the server 30, the processor 101 of the communication device 100 sends the received operation command signal to the ECU 110 through the communication interface 104 and the in-vehicle network. When the first period of time (e.g. 7 to 9 days) elapses after the internal combustion 130 has stopped operating, the processor 101 of the communication device 100 according to the embodiment switches the communication device 100 from the standby mode to the off mode. When the user gets in the vehicle 10 and starts the internal combustion engine 130 (for example, by turning on the power switch or the ignition switch) after the communication device 100 has been switched from the standby mode to the off mode, a wakeup signal is sent from the ECU 110 (described later) to the communication device 100, whereby the processor 101 switches the communication device from the off mode to the standby mode.

The air conditioning system 120 is a mechanical air conditioning system that cools or heats the cabin of the vehicle 10 using the power of the internal combustion engine 130. Alternatively, the air conditioning system 120 may be an electric air conditioning system that cools or heats the cabin of the vehicle 10 using the electrical power produced by the generator 140.

The generator 140 produces electrical power by converting the kinetic energy produced by the internal combustion engine 130 into electrical energy. The generator 140 may produce electrical power by what is called regeneration, that is, the conversion of the kinetic energy of the driving wheels into electrical energy while the vehicle 10 is decelerating.

The ECU 110 is a computer that controls the air conditioning system 120, the internal combustion engine 130, the generator 140 and other in-vehicle equipment. According to the embodiment, upon receiving an operation command signal sent from the communication device 100, the ECU 110 causes the in-vehicle equipment to operate according to the operation command signal. If the received operation command signal is a signal for remote air conditioning, the ECU 110 causes the internal combustion engine 130 to start and the air conditioning system 120 and the generator 140 to operate. In this way, it is possible to cool or heat the cabin of the vehicle 10 and to charge the battery 105 of the communication device 100.

### ((User's Terminal))

Next, the hardware configuration of the user's terminal 20 will be described. The user's terminal 20 used in the system according to the embodiment is a computer that is used by the user of the vehicle 10. For example, the user's terminal 20 may be a smartphone, a tablet terminal, a wearable computer, or a personal computer (PC). As illustrated in FIG. 2, the user's terminal 20 according to the embodiment has a processor 201, a main storage unit 202, an auxiliary storage unit 203, an input and output device 204, and a communication interface 205. The processor 201, the main storage unit 202, the auxiliary storage unit 203, the input and output device 204, and the communication interface 205 are interconnected by buses.

While FIG. 2 illustrates only the hardware components related to remote operations, the user's terminal can have other hardware components than those illustrated in FIG. 2.

The processor 201, the main storage unit 202, and the auxiliary storage unit 203 of the user's terminal 20 are respectively similar to the processor 101, the main storage unit 102, and the auxiliary storage unit 103 of the communication device 100 and will not be described in further detail. However, it should be noted that the auxiliary storage unit 203 of the user's terminal 20 stores a special-purpose program(s) (application program) configured to cause the processor 201 to implement functions related to remote operations.

The input and output device 204 receives input operations performed by the user and presents information to the users. For example, the input and output device 204 includes a touch panel display and its control circuit. The input and output device 204 according to the embodiment is configured to output a menu screen for remote operations and to receive input operations performed on the menu screen. The input and output device 204 is also configured to output an operation screen for the remote operation selected on the menu screen and to receive operations performed on the operation screen.

The communication interface 205 includes an interface for connecting the user's terminal 20 to the network N1. The communication interface 205 connects the user's terminal 20 to the network N1 using mobile communications, wireless communications, such as Wi-Fi (registered trademark), or a LAN. The communication interface 205 according to the embodiment communicates with the server 30 through the network N1.

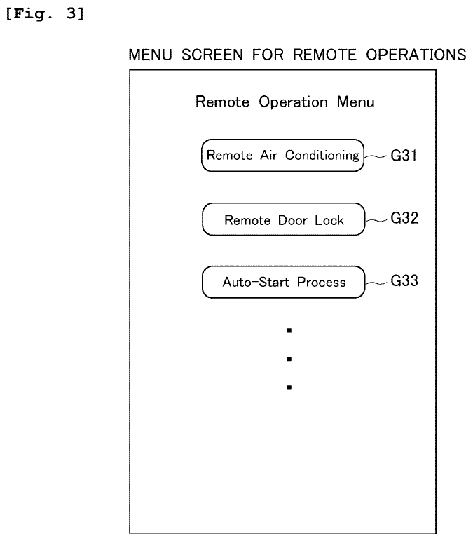

When the operation of: a special-purpose program for remote air conditioning is input to the input and output device 204 of the user's terminal 20 configured as above, the processor 201 of the user's terminal 20 causes the input and output device 204 to output the menu screen for remote operations. The menu screen for remote operations is a screen that presents a list of operations that can be performed remotely. For example, as illustrated in FIG. 3, the menu screen for remote operations may contain a GUI part for selecting remote air conditioning (“Remote Air Conditioning” button G31 in FIG. 3), a GUI part for selecting remote door locking (“Remote Door Lock” button G32 in FIG. 3), a GUI part for selecting auto-start process (“Auto-Start Process” button G33 in FIG. 3), and other parts.

When the operation of selecting one of the operations is input to the input and output device 204 while the menu screen for remote operations is displayed on the input and output device 204 as described above, the processor 201 causes the input and output device 204 to output the operation screen for the selected operation. For example, when the operation of selecting the auto-start process (e.g. the operation of tapping or clicking the “Auto-Start Process” button G33 in FIG. 3) is input to the input and output device 204 while the menu screen for remote operations is displayed on the input and output device 204, the processor 201 causes the input and output device 204 to output the operation screen for the auto-start process.

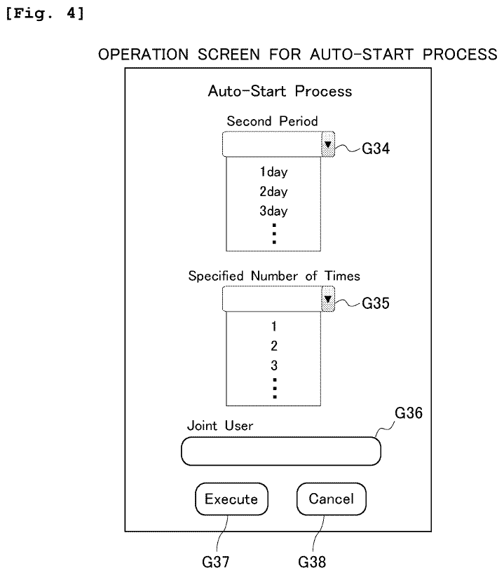

FIG. 4 illustrates an example of the operation screen for the auto-start process. The example operation screen for the auto-start process in FIG. 4 contains a GUI part for specifying the second period of time (pull-down menu G34 in FIG. 4), a GUI part for specifying the specified number of times (pull-down menu G35 in FIG. 4), a GUI part for entering the contact address of a joint user, such as an electronic mail address of a terminal used by the joint user (input field G36 in FIG. 4), a GUI part for executing the auto-start process (“Execute” button G37 in FIG. 4), and a GUI part for cancelling the operation of the auto-start process (“Cancel” button G 38 in FIG. 4). The options of the second period of time that can be chosen by the pull-down menu G34 in FIG. 4 are shorter than the first period of time mentioned above. For example, if the first period of time is nine days, the options of the second period of time that can be chosen by the pull-down menu G34 in FIG. 4 are one through eight days. The joint user mentioned above refers to a user who jointly owns or uses the vehicle 10 with the user. For example, the joint user can be a member of the user's family. The input of the contact address of the joint user is not necessarily a requirement.

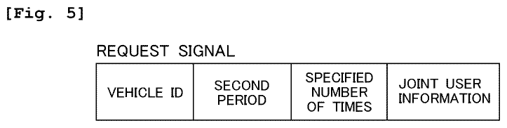

When the operation screen for the auto-start process is displayed on the input and output device 204, if the second period of time and the specified number of times are specified, the contact address of the joint user is input, and then the operation for executing the auto-start process (i.e. the operation of tapping or clicking the “Execute” button G37 in FIG. 4) is input to the input and output device 204, the processor 201 generates a request signal. For example, as illustrated in FIG. 5, the request signal contains the vehicle ID of the vehicle 10, information on the second period of time specified on the operation screen for the auto-start process, information on the specified number of times specified on the operation screen for the auto-start process, and joint user information. The joint user information is the contact address of the joint user. When the operation screen for the auto-start process is displayed on the input and output device 204, if the second period of time and the specified number of times are specified, and then the operation for executing the auto-start process (i.e. the operation of tapping or clicking the “Execute” button G37 in FIG. 4) is input to the input and output device 204 without the input of joint user information, the processor 201 generates a request signal that does not contain joint user information. The request signal generated as above is sent to the server 30 through the communication interface 205.

### ((Server))

Next, an example of the hardware configuration of the server 30 will be described. The server 30 according to the embodiment is a computer operated by the provider of the remote air conditioning service. For example, the provider of the remote air conditioning service is the manufacturer of the vehicle 10 or a company contracted by the manufacturer. As illustrated in FIG. 2, the server 30 has a processor 301, a main storage unit 302, an auxiliary storage unit 303, and a communication interface 304.

While FIG. 2 illustrates only the hardware components related to remote operations, the server 30 can have other hardware components than those illustrated in FIG. 2.

The processor 301, the main storage unit 302, and the auxiliary storage unit 303 of the server 30 are respectively similar to the processor 101, the main storage unit 102, and the auxiliary storage unit 103 of the communication device 100 and will not be described in further detail. However, it should be noted that the auxiliary storage unit 303 of the server 30 stores data including vehicle data 331 in addition to an OS and a special-purpose program(s) (application program) configured to cause the processor 301 to implement functions related to remote operations.

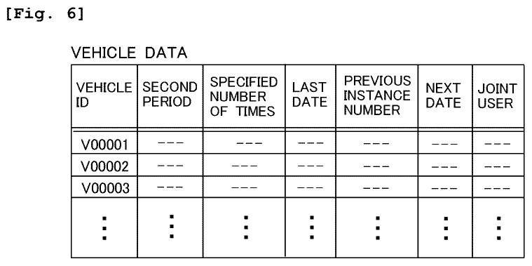

Here, the vehicle data 331 stored in the auxiliary storage unit 303 will be described. What is stored as the vehicle data 331 according to the embodiment is data related to the vehicles 10 for which the auto-start process is to be performed among the vehicles 10 managed by the server 30. FIG. 6 schematically illustrates an example of the vehicle data 331. In the example illustrated in FIG. 6, the vehicle data 331 include a plurality of records for respective individual vehicles. These records will also be referred to as “individual vehicle records” hereinafter. Each individual vehicle record is created when the sever 30 receives a request signal sent from the user's terminal 20. Each of the individual vehicle records has the field of vehicle ID, second period, specified number, last date, previous instance number, next date, and joint user.

The vehicle ID field records information that identifies each of the plurality of vehicles 10 for which the auto-start process is to be performed. The information recorded in the vehicle ID field may be information that identifies the communication device 100 of the vehicle 10.

The second period field records the second period of time associated with each of the plurality of vehicles 10 for which the auto-start process is to be performed. The information recorded in the second period field is the same as the second period of time specified by the request signal sent from the user's terminal 20 associated with each vehicle 10 to the server 30.

The specified number field records the specified number of times associated with each of the plurality of vehicles 10 for which the auto-start process is to be performed. The information recorded in the specified number field is the same as the specified number of times specified by the request signal sent from the user's terminal 20 associated with each vehicle 10 to the server 30.

The last date field records the date the remote air conditioning command signal was last sent to each vehicle 10 by executing the auto-start process. When an individual vehicle record is newly created, the last date field may record the date the internal combustion engine 130 was last stopped before the creation of the record.

The previous instance number field records the number of times the remote air conditioning command signal has sent to each vehicle 10 by the execution of the auto-start process in the past.

The next date field records the next date the remote air conditioning command signal will be sent to each vehicle 10 by executing the auto-start process. The information recorded in the next date field may be the date the second period of time (recorded in the second period field) after the date recorded in the last date field.

The joint user field records the contact address of a joint user of each of the plurality of vehicles 10 for which the auto-start process is to be performed. For example, the contact address is the electronic mail address of a terminal used by the joint user. The information recorded in the joint user field is the same as the joint user information contained in the request signal sent from the user's terminal 20 associated with each vehicle 10 to the server 30. In cases where the joint user information is not contained in the request signal, the joint user field may be left blank.

Referring back to FIG. 2, the communication interface 304 of the server 30 is a communication interface for connecting the server 30 to the network N1. For example, the communication interface 304 may include a network interface board and a wireless communication interface for wireless communication. According to the embodiment, the communication interface 304 communicates with the user's terminal 20 and the communication device 100 through the network N1.

One or more hardware components of the server 30 can be eliminated, replaced by other components, and/or augmented by other components in an appropriate manner depending on the mode of implementation. For example, the server 30 may include a plurality of processors. The server 30 may include a plurality of computers. The server apparatus 30 may include an external storage unit that is connected to it through the network N1.

### (Software Configuration of Server)

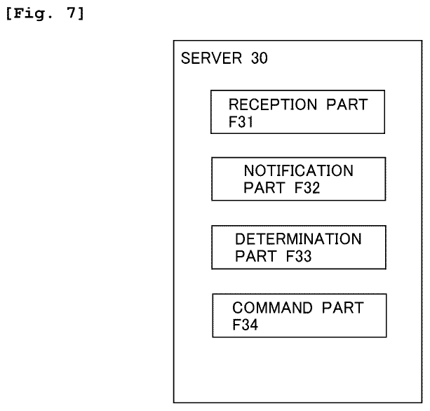

Next, the software configuration of the sever 30 will be described with reference to FIG. 7. FIG. 7 is a block diagram schematically illustrating an example of the software configuration of the server 30. The processor 301 of the server 30 executes a program(s) stored in the auxiliary storage unit 303, whereby the server 30 operates as a computer that has a reception part F31, a notification part F32, a determination part F33, and a command part F34 as software modules.

Some or all of the reception part F31, the notification part F32, the determination part F33, and the command part F34 may be implemented by a hardware circuit(s), such as an ASIC (Application Specific Integrated Circuit) or an FPGA (Field Programmable Gate Array).

The reception part F31 is configured to receive request signals sent from the user's terminals 20. Upon receiving a request signal, the reception part F31 accesses the vehicle data 331 stored in the auxiliary storage unit 303 to add a new individual vehicle record for the vehicle 10 with which the request signal is associated (namely, the vehicle 10 for which the auto-start process is to be performed). What is recorded respectively in the vehicle ID field, the second period field, the specified number field, and the joint user field of this new record is the vehicle ID, the second period of time, the specified number of times, and the joint user information that are contained or specified in the request signal. If the request signal does not contain the joint user information, the joint user field is left blank. What is recorded in the last date field is the date the internal combustion engine 130 was last stopped before the request signal was received. The reception part 31 may obtain the date the internal combustion engine 130 was last stopped before the request signal was received by communicating with the communication device 100 of the vehicle 10 through the communication interface 304. The previous instance number field is left blank. What is recorded in the next date field is the second period of time after the date recorded in the last date field (that is, the date the internal combustion engine 130 was last stopped before the request signal was received).

When an individual vehicle record of the vehicle 10 associated with the request signal is added to vehicle data 331, the notification part F32 sends a process start notification to the contact address recorded in the joint user field (e.g. the electronic mail address of the terminal used by the joint user). The process start notification is a notification that indicates that the auto-start process is about to be started. The process start notification is sent to the joint user's terminal through the communication interface 304 of the server 30. In the case where the joint user field is blank, the notification part F32 does not send the process start notification.

The determination part F33 accesses the vehicle data 331 stored in the auxiliary storage unit 303 at regular intervals (e.g. every day) to determine whether there is a vehicle 10 of which the next date has come, in other words, whether there is an individual vehicle record where the date recorded in the next date field is the same as the present (or today's) date. If it is determined that there is a vehicle of which the next date has come, the determination part F33 determines whether the number of times recorded in the previous instance number field of the individual vehicle record associated with this vehicle 10 is less than the number of times recorded in the specified number field. If the number of times recorded in the previous instance number field is not less than the specified number of times recorded in the specified number field, the determination part F33 deletes the individual vehicle record associated with this vehicle from the vehicle data 331. Thus, the execution of the auto-start process for this vehicle is ended. In contrast, if the number of times recorded in the previous instance number field is less than the specified number of times recorded in the specified number field, then the processor 301 of the server 30 operates as the command part F34.

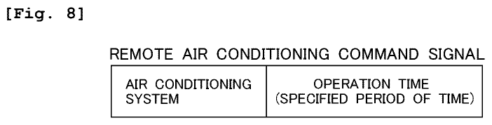

The command part F34 generates the remote air conditioning command signal for the vehicle 10 of which the next date has come. As illustrated in FIG. 8, the remote air conditioning command signal is a signal containing information that specifies the target in-vehicle equipment to which the command is directed (in this case, the air conditioning system 120), and the operation time of the target in-vehicle equipment (in this case, the specified period of time). The specified period of time specified by the remote air conditioning command signal is the operation time of the air conditioning system 120 that is needed to charge the battery 105 of the communication device 100 to increase its remaining capacity, such as the SoC (State of Charge), equal to or greater than a threshold. For example, this threshold is set to a remaining capacity of the battery 105 that allows the communication device 100 to remain in the standby mode longer than the first period of time. In a mode, the specified period of time may be the operation time of the air conditioning system 120 (or the operation time of the internal combustion engine 130) that is needed to charge the battery 105 from 0% to a level equal to or higher than the threshold. In another mode, the specified period of time may be the operation time of the air conditioning system 120 (or the operation time of the internal combustion engine 130) that is needed to charge the battery 105 from the level at the time of the next date to a level equal to or higher than the threshold. The remote air conditioning command signal generated by the command part F34 is sent to the communication device 100 of the vehicle 10 of which the next date has come through the communication interface 304.

The after sending the remote air conditioning command signal to the communication device 100 of the vehicle 10 of which the next date has come, the command part F34 accesses the vehicle data 331 stored in the auxiliary storage unit 303 to update the information recorded in the individual vehicle record associated with this vehicle 10.

Specifically, the command part F34 changes the date recorded in the last date field of the individual vehicle record to the date on which the remote air conditioning command signal was sent this time (namely, the present date). Moreover, the command part F34 increments the number of times recorded in the previous instance number field of the individual vehicle record by one. Furthermore, the command part F34 adds the second period of time recorded in the second period field of the individual vehicle record to the present date to calculate the updated next date. Then, the command part F34 changes the date recorded in the next date field of the individual vehicle record to the updated next date calculated as above.

The software configuration of the server 30 is not limited to that illustrated in FIG. 7. One or some of the components of the server 30 can be eliminated, replaced by other components, and/or augmented by other components in an appropriate manner depending on the mode of implementation. In a mode, the reception part F31 may be configured to receive remote operation signals sent from the user's terminal 20 also. In that case, the reception part F31 may be configured to transfer the received remote operation signal to the command part F34. The command part F34 may be configured to send an operation command signal for causing the target in-vehicle equipment according to the mode of operation specified by the remote operation signal to the communication device 100 of the vehicle 10 to which the remote operation signal is directed.

### (Processes Performed by Server)

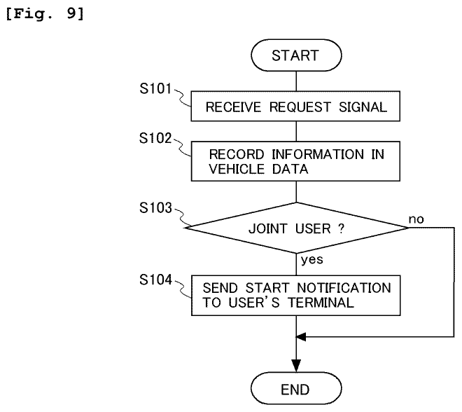

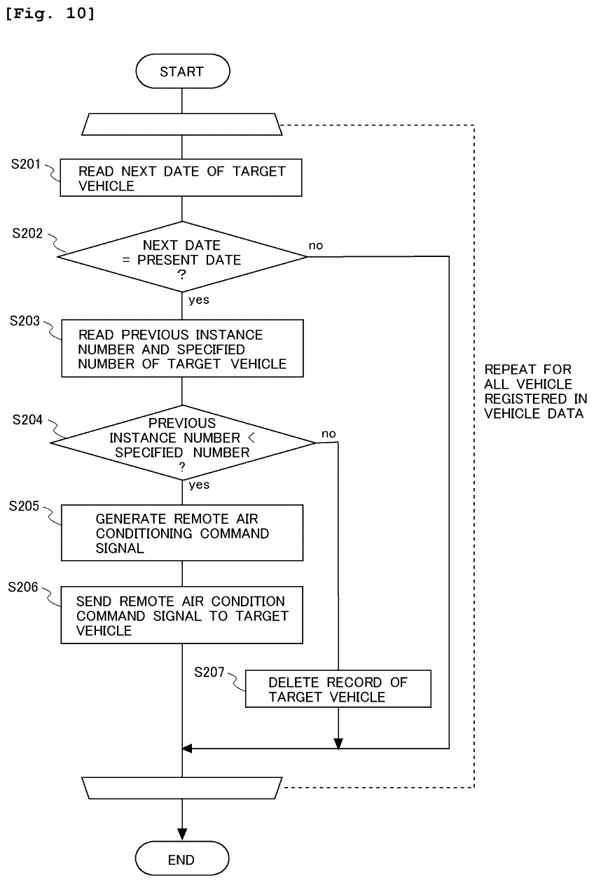

Processes performed by the server 30 according to the embodiment will be described with reference to FIGS. 9 and 10. FIG. 9 is a flow chart of an example processing routine executed in the server 30. This processing routine is triggered by the reception of the request signal sent from the user's terminal 20. FIG. 10 is a flow chart of an example processing routine executed by the server 30 at regular intervals (e.g. every day). While the processing routines according to the flow charts of FIGS. 9 and 10 are executed by the processor 301 of the server 30, software modules of the server 30 will be mentioned in the following description as the elements that execute the processing in the routines.

In the processing routine according to the flow chart of FIG. 9, when the communication interface 304 of the server 30 receives a request signal from the user's terminal 20, the processor 301 of the server 30 executes a program stored in the auxiliary storage unit 303 to operate as the reception part F31. The reception part F31 receives the request signal sent from the user's terminal 20 through the communication interface 304 (step S101). After completing the processing of step S101, the reception part F31 executes the processing of step S102.

In step S102, the reception part F31 records information on the vehicle 10 to which the request signal received in step S101 is directed (namely, the vehicle 10 for which the auto-start process is to be performed) in the vehicle data 331 stored in the auxiliary storage unit 303. Specifically, the reception part F31 firstly accesses the vehicle data 331 stored in the auxiliary storage unit 303 to add a new individual vehicle record. Then, the reception part F31 records the vehicle ID, the second period of time, the specified number of times, and the joint user information contained in the request signal respectively to the vehicle ID field, the second period field, the specified number field, and the joint user field of the newly added individual vehicle record. Moreover, the reception part F31 communicates with the communication device 100 of the target vehicle 10 through the communication interface 304 to obtain the date on which the operation of the internal combustion engine 130 was last stopped before the present time. Then, the reception part F31 records the date thus obtained from the communication device 100 in the last date field of the newly-added individual vehicle record. Moreover, the reception part F31 records the date calculated by adding the second period of time to the date obtained from the communication device 100 in the next date field of the newly-added individual vehicle record. The reception part F31 leaves the previous instance number field of the newly added individual vehicle record blank. If the request signal received in step S101 does not contain the joint user information, the reception part F31 leaves the joint user field of the newly-added individual vehicle record blank. After the reception part F31 completes the processing of step S102, the processor 301 of the server 30 operates as the notification part F32 to execute the processing of step S103.

In step S103, the notification part F32 determines whether joint user information is recorded in the joint user field of the individual vehicle record added in step S102. In other words, the notification part F32 determines whether there is a joint user who shares the vehicle 10 with the user of the user's terminal 20. If joint user information is not recorded in the joint user field of the individual vehicle record added in step S102 (in other words, if the joint user field is blank), the notification part F32 determines that there is no joint user who shares the vehicle 10 with the user of the user's terminal 20 (negative answer to step S103). Then, the execution of the processing routine according to the flow chart of FIG. 9 is terminated. If joint user information is recorded in the joint user field of the individual vehicle record added in step S102, the notification part F32 determines that there is a joint user who shares the vehicle 10 with the user of the user's terminal 20 (affirmative answer to step S103). Then, the notification part F32 executes the processing of step S104.

In step S104, the notification part F32 sends a process start notification to the contact address (i.e. the terminal of the joint user) recorded in the joint user field of the individual vehicle record added in step S102 through the communication interface 304. The process start notification is a notification that notifies that the auto-start process is about to be executed for the vehicle 10 associated with the request signal. After the notification part F32 completes the processing step S104, the execution of the processing routine according to the flow chart of FIG. 9 is terminated.

Then, the processor 301 of the server 30 executes the processing routine according to the flow chart of FIG. 10 at regular intervals. The processing of steps S201 through S207 in the flow chart of FIG. 10 is executed for each of one or more vehicles 10 that are registered in the vehicle data 331 stored in the auxiliary storage unit 303.

In the processing routine according to the flow chart of FIG. 10, the processor 301 of the server 30 firstly executes a program stored in the auxiliary storage unit 303 to operate as the determination part F33. The determination part F33 accesses the individual vehicle record of the target vehicle 10 among the one or more individual vehicle records registered in the vehicle data 331 to read the next date recorded in the next date field (step S201). After completing the processing of step S201, the determination part F33 executes the processing of step S202.

In step S202, the determination part F33 determines whether the next date read in step S201 has come. Specifically, the determination part F33 determines whether the next date read in step S201 is the same as the present date. If the next date read in step S201 is the same as the present date (affirmative answer to step S202), the determination part F33 executes the processing of step S203. If the next date read in step S201 is not the same as the present date (negative answer to step S202), the processing of step S201 onward is executed for another vehicle 10 registered in the vehicle data 331 (namely a vehicle 10 for which the processing of steps S201 through S207 has not been executed yet).

In step S203, the determination part F33 reads the number of previous instances and the specified number of times respectively recorded in the previous instance number field and the specified number field of the individual vehicle record associated with the target vehicle 10.

After completing the processing of step S203, the determination part F33 executes the processing of step S204.

In step S204, the determination part F33 compares the number of previous instances and the specified number of times read in step S203 to determine whether the number of previous instances is less than the specified number of times. If the number of previous instances is less than the specified number of times (affirmative answer to step S204), the processor 301 of the server 30 operates as the command part F34 to execute the processing of step S205.

In step S205, the command part F34 generates a remote air conditioning command signal for the target vehicle 10. As described above with reference to FIG. 8, the remote air conditioning command signal is a signal that contains information specifying the air conditioning system 120 as the target in-vehicle equipment and the operation time of the air conditioning system 120. The operation time specified by the remote air conditioning command signal may be equal to the specified time mentioned above. The specified time is the operation time of the air conditioning system 120 (or the operation time of the internal combustion engine 130) that is needed to charge the battery 105 to a level equal to or higher than the threshold. After completing the processing of step S205, the command part F34 executes the processing of step S206.

In step S206, the command part F34 sends the remote air conditioning command signal generated in step S205 to the communication device 100 of the target vehicle 10 through the communication interface 304. After the command part F34 completes the processing of step S206, the processing of step S201 onward is executed for another vehicle 10 that is registered in the vehicle data 331 (or a vehicle 10 for which the processing of steps S201 through S207 has not been executed yet).

If step S204 is answered in the negative (namely, if the number of previous instances is not less than the specified number of times), the determination part F33 executes the processing of step S207. In step S207, the determination part F33 accesses the vehicle data 331 stored in the auxiliary storage unit 303 to delete the individual vehicle record associated with the target vehicle 10. After the determination part F33 completes the processing of step S207, the processing of step S201 onward is executed for another vehicle 10 that is registered in the vehicle data 331 (or a vehicle 10 for which the processing of steps S201 through S207 has not been executed yet).

After the processing of steps S201 through S207 has been executed for all the vehicles 10 registered in the vehicle data 331, the processor 301 of the server 30 terminates the execution of the processing routine according to the flow chart of FIG. 10.

### (Operation and Advantageous Effects of Embodiment)

According to the embodiment described above, when the user of a vehicle 10 sends a request signal to the server 30 using the user's terminal 20, the auto-start process is performed for this vehicle 10. In the auto-start process, the server 30 automatically sends the remote air conditioning command signal to the vehicle 10 before the communication device 100 of the vehicle 10 is switched to the off mode after the operation of the internal combustion engine 130 of the vehicle 10 has stopped operating. Consequently, the vehicle 10 can perform the remote air conditioning according to the remote air conditioning command signal. When the remote air conditioning is performed in the vehicle 10, the internal combustion engine 130 is started, and the air conditioning system 120 and the generator 140 are caused to operate. When the specified period of time elapses after the start of the internal combustion engine 130, the internal combustion engine 130 is stopped operating, and the operation of the air conditioning system 120 and the generator 140 is stopped. As a result, the start point of the first period is reset, and the battery 105 of the communication device 100 is charged for the specified period of time.

In the auto-start process according to the embodiment, the server 30 automatically sends the remote air conditioning command signal to the vehicle 10 every time the second period of time elapses after the internal combustion engine 130 has stopped operating. This allows the communication device 100 of the vehicle 10 to remain in the standby mode for an extended period of time. This is effective in preventing situations where the communication device 100 of the vehicle 10 is unable to receive signals from the server 30 when the user of the vehicle 10 tries to use a remote service. However, in the auto-start process according to the embodiment, the number of times of sending the remove air conditioning command signal is limited to a number of times specified by the user. This is effective in preventing the remaining amount of fuel from becoming unduly small due to the execution the auto-start process.

As above, the system according to the embodiment can effectively prevent inconvenience to the user of the remote service.

### <Modification>

The system according to the embodiment described above is configured to limit the number of times of sending the remote air conditioning command signal in the auto-start process to a specified number or less. Described in the following as a modification is a case where the system allows the auto-start process to be executed only before a time limit. The time limit is such that the execution of the auto-start process is terminated after the time limit expires. In the following description of the modification, only the features that are different from the above-described embodiment will be described, but like features will not be described.

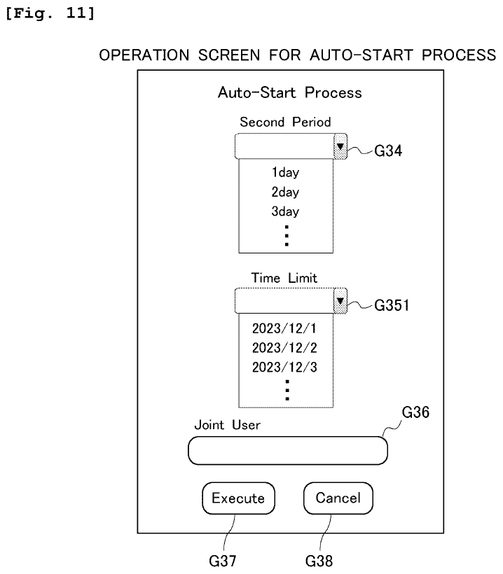

The user's terminal 20 according to the modification is configured to receive a designation of the time limit by the user. Specifically, when the operation of selecting the auto-start process (e.g. the operation of tapping or clicking the “Auto-Start Process” button G33 in FIG. 3) is input to the input and output device 204 while the menu screen for remote operations (see, for example, FIG. 3) is displayed on the input and output device 204 of the user's terminal 20 according to the modification, the processor 201 causes the input and output device 204 to output the operation screen for the auto-start process shown in FIG. 11.

FIG. 11 illustrates an example of the operation screen for the auto-start process according to the modification. As illustrated in FIG. 11, the operation screen for the auto-start process according to the modification may contain a GUI part for specifying the second period of time (pull-down menu G34 in FIG. 11), a GUI part for specifying the time limit (pull-down menu G351 in FIG. 11), a GUI part for entering the contact address of a joint user, such as an electronic mail address of a terminal used by the joint user (input field G36 in FIG. 11), a GUI part for executing the auto-start process (“Execute” button G37 in FIG. 11), and a GUI part for cancelling the operation of the auto-start process (“Cancel” button G38 in FIG. 11). As above, the operation screen for the auto-start process according to the modification contains the pull-down menu G351 for specifying the time limit for the auto-start process in place of the pull-down menu G35 shown in FIG. 3, which is the GUI part for specifying the specified number of times.

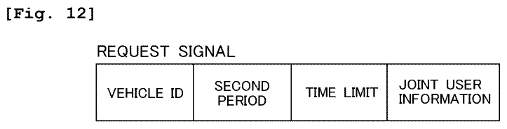

When the operation screen for the auto-start process is displayed on the input and output device 204 as illustrated in FIG. 11, if the second period of time and the time limit are specified, the contact address of the joint user is input, and then the operation for executing the auto-start process (i.e. the operation of tapping or clicking the “Execute” button G37 in FIG. 11) is input to the input and output device 204, the processor 201 of the user's terminal 20 generates a request signal. As illustrated in FIG. 12, the request signal according to the modification contains the vehicle ID of the vehicle 10, information on the second period of time specified on the operation screen for the auto-start process, information on the time limit specified on the operation screen for the auto-start process, and joint user information. The request signal generated by the processor 201 of the user's terminal 20 is sent to the server 30 through the communication interface 205.

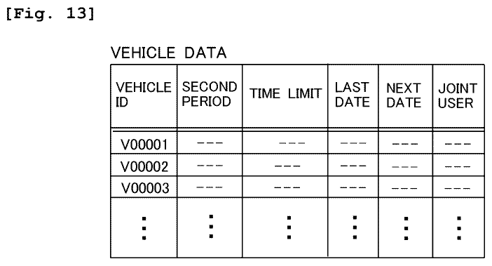

Next, the vehicle data 331 stored in the auxiliary storage unit 303 of the server 30 according to the modification will be described with reference to FIG. 13. FIG. 13 schematically illustrates an example of the vehicle data 331. As illustrated in FIG. 13, each individual vehicle record in the vehicle data 331 according to the modification has the fields of vehicle ID, second period, time limit, last date, next date, and joint user. The information recorded in the vehicle ID field, the second period field, the last date field, the next date field, and the joint user field is the same as that in the above-described embodiment (see, for example, FIG. 6). What is recorded in the time limit field is the time limit set for each of the vehicles 10 for which the auto-start process is to be performed. The information recorded in the time limit field is the same as the time limit specified by the request signal sent from the user's terminal 20 associated with each vehicle 10 to the server 30.

Next, the software configuration of the server 30 according to the modification will be described. Like the server 30 according to the above-described embodiment, the server 30 according to the modification has a reception part F31, a notification part F32, a determination part F33, and a command part F34 as software modules. The reception part F31, the notification part F32, and the command part F34 of the modification are the same as the reception part F31, the notification part F32, and the command part F34 of the above-described embodiment.

The determination part F33 according to the modification accesses the vehicle data 33 stored in the auxiliary storage unit 303 at intervals to regular determined whether there is a vehicle 10 of which the next date has come. When it is determined that there is a vehicle 10 of which the next date has come, the determination part F33 determines whether the time limit recorded in the time limit field of the individual vehicle record associated with this vehicle has expired (in other words, whether the present date is after the time limit). If the time limit recorded in the time limit field has expired, the determination part F33 deletes the individual vehicle record associated with this vehicle from the vehicle data 331. Then, the execution of the auto-start process for this vehicle is terminated. If the time limit recorded in the time limit field has not expired, the processor 301 of the server 30 operates as the command part F34.

### (Process Performed by Server)

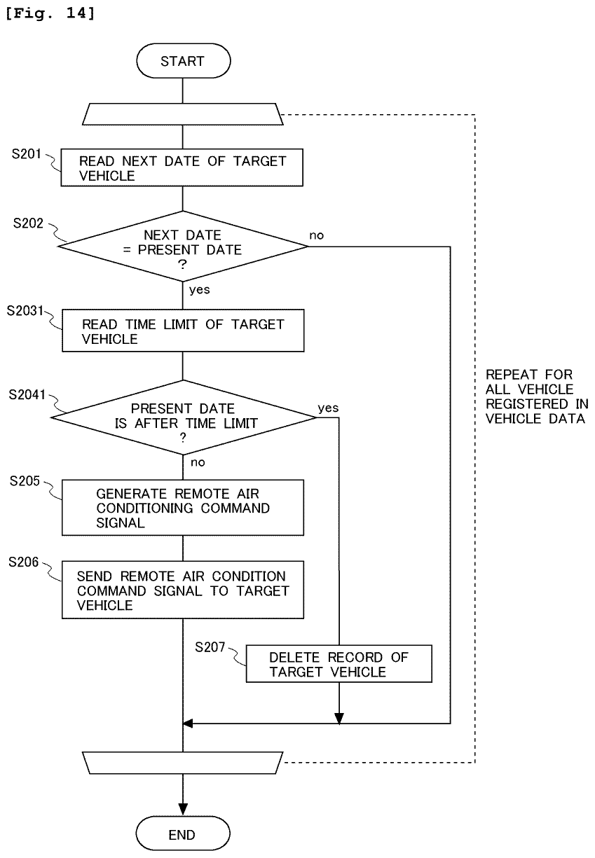

A process performed by the server 30 according to the modification will be described with reference to FIG. 14. FIG. 14 is a flow chart of an example processing routine executed by the server 30 at regular intervals (e.g. every day). In FIG. 14, the steps of processing that are the same as those in the processing routine according to the flow chart of FIG. 10 are referred to by the same reference signs and will not be described in further detail.

In the processing routine according to the flow chart of FIG. 14, if step S202 is answered in the affirmative, in other words, if it is determined that the next date has come, the determination part F33 executes the processing of step S2031. In step S2031, the determination part F33 reads the time limit recorded in the time limit field of the individual vehicle record associated with the target vehicle 10. After completing the processing of step S2031, the determination part F33 executes the processing of step S2041.

In step S2041, the determination part F33 determines whether the time limit read in step S2031 has expired, in other words, whether the present date is after the time limit. If the time limit read in step S2031 has not expired (negative answer to step S2041), the processor 301 of the server 30 operates as the command part F34 to execute the processing of step S205. If the time limit read in step S2031 has expired (affirmative answer to step S2041), the determination part F33 executes the processing of step S207.

### (Operation and Advantageous Effects of Modification)

According to the modification, when the time limit specified by the user expires, the execution of the auto-start process is terminated. This is effective in preventing the remaining amount of fuel from becoming too low due to the execution of the auto-start process.

### <Others>

The above embodiment and modification are merely examples, but the technology disclosed herein can be implemented with appropriate changes and modifications without departing from its essence. For example, while according to the above embodiment and modification the second period of time and the specified number of times (or the time limit) are arbitrarily specified by the user, at least one of the second period of time and the specified number of times (or the time limit) may be automatically determined by the server 30. Besides the second period of time and the specified number of times (or the time limit), the time slot during which the remote air conditioning command signal is sent from the server 30 to the vehicle 10 may be arbitrarily specified by the user. After the server 30 has sent the remote air conditioning command signal to the vehicle 10, the vehicle 10 may send a signal indicating whether remote air conditioning has performed successfully to the server 30. Then, the server 30 may send this signal to the user's terminal 20 (and the joint user's terminal).

The processes and features described in the present disclosure may be adopted in any combination, if it is technically feasible to do so. One or more processes that have been described as processes performed by one apparatus may be performed by a plurality of apparatuses in a distributed manner. One or more processes that have been described as processes performed by different apparatuses may be performed by one apparatus.

The technology disclosed herein can be implemented by supplying a computer program or programs configured to implement the functions described in the above description of the embodiment to the server 30 to cause one or more processors of the server 30 to read out and to execute the program or programs. Such a computer program or programs may be supplied to a computer by a non-transitory, computer-readable storage medium that can be connected to a system bus of the computer or through a network. The no-transitory, computer-readable storage medium is a recording medium capable of storing information such as data and programs electrically, magnetically, optically, mechanically, or chemically such that computers can read the information. For example, the recording medium may be any type of disc including a magnetic disc, such as a floppy disc (registered trademark) and a hard disk drive (HDD), and an optical disc, such as a CD-ROM, a DVD, and a Blu-ray disc. The recording medium may also be a read-only memory (ROM), a random access memory (RAM), an EPROM, an EEPROM, a magnetic card, a flash memory, an optical card, a solid state drive, or other medium.

What is claimed is:

1. An information processing apparatus for controlling a vehicle having a communication function related to remote operation that is switched to off mode in response to a first period of time elapses after an internal combustion engine has stopped operating, comprising a controller including at least one processor,
the controller configured to execute an auto-start process, the auto start-process being the process of sending a start command for causing the internal combustion engine to operate for a specified period of time in response to a second period of time that is shorter than the first period of time elapses after the internal combustion engine has stopped operating.

2. The information processing apparatus according to claim 1, wherein executing the auto-start process comprises:
in response to the second period of time elapses after the internal combustion engine has stopped operating, determining whether the number of previous instances of sending the start command is less than a specified number of times; and
if it is determined that the number of previous instances is less than the specified number of times, sending the start command to the vehicle.

3. The information processing apparatus according to claim 2, wherein the controller is configured to further execute the processing of:
receiving a request signal requesting the execution of the auto-start process from a first terminal used by a user of the vehicle, the request signal containing information specifying the second period of time and the specified number of times; and
starting the execution of the auto-start process according to the second period of time and the specified number of times specified by the request signal.

4. The information processing apparatus according to claim 3, wherein the controller is configured to further execute the processing of sending a notification indicating that the execution of the auto-start process is about to start to a second terminal used by a joint user of the vehicle in response to the request signal is received.

5. The information processing apparatus according to claim 1, wherein executing the auto-start process comprises:
in response to the second period of time elapses after the internal combustion engine has stopped operating, determining whether a time limit for the auto-start process has expired; and
if it is determined that the time limit has not expired, sending the start command to the vehicle.

6. The information processing apparatus according to claim 5, wherein the controller is configured to further execute the processing of:
receiving a request signal requesting the execution of the auto-start process from a first terminal used by a user of the vehicle, the request signal containing information specifying the second period of time and the time limit; and
starting the execution of the auto-start process according to the second period of time and the time limit specified by the request signal.

7. The information processing apparatus according to claim 6, wherein the controller is configured to further execute the processing of sending a notification indicating that the execution of the auto-start process is about to start to a second terminal used by a joint user of the vehicle in response to the request signal is received.

8. The information processing apparatus according to claim 1, wherein the vehicle is provided with a battery that supplies electrical power for the communication function to operate and is charged using the power that is produced while the internal combustion engine is in operation, and the specified period of time is a period of time that is needed to charge the battery to a level equal to or higher than a threshold.

9. The information processing apparatus according to claim 1, wherein the start command comprises a command for starting the internal combustion engine and causing an air conditioning system provided in the vehicle to operate.

10. An information processing method for controlling a vehicle having a communication function related to remote operation that is switched to off mode in response to a first period of time elapses after an internal combustion engine has stopped operating, comprising executing an auto-start process by a computer,
the auto-start process being the process of sending a start command for causing the internal combustion engine to operate for a specified period of time in response to a second period of time that is shorter than the first period of time elapses after the internal combustion engine has stopped operating.

11. The information processing method according to claim 10, wherein executing the auto-start process comprises:
in response to the second period of time elapses after the internal combustion engine has stopped operating, determining whether the number of previous instances of sending the start command is less than a specified number of times; and
if it is determined that the number of previous instances is less than the specified number of times, sending the start command to the vehicle.

12. The information processing method according to claim 11, wherein the computer further executes the processing of:
receiving a request signal requesting the execution of the auto-start process from a first terminal used by a user of the vehicle, the request signal containing information specifying the second period of time and the specified number of times; and
starting the execution of the auto-start process according to the second period of time and the specified number of times specified by the request signal.

13. The information processing method according to claim 12, wherein in response to the computer receives the request signal, the computer further executes the processing of sending a notification indicating that the execution of the auto-start process is about to start to a second terminal used by a joint user of the vehicle.

14. The information processing method according to claim 10, wherein executing the auto-start process comprises:
in response to the second period of time elapses after the internal combustion engine has stopped operating, determining whether a time limit for the auto-start process has expired; and
if it is determined that the time limit has not expired, sending the start command to the vehicle.

15. The information processing method according to claim 14, wherein the computer further executes the processing of:
receiving a request signal requesting the execution of the auto-start process from a first terminal used by a user of the vehicle, the request signal containing information specifying the second period of time and the time limit; and
starting the execution of the auto-start process according to the second period of time and the time limit specified by the request signal.

16. The information processing method according to claim 15, wherein the computer further executes the processing of sending a notification indicating that the execution of the auto-start process is about to start to a second terminal used by a joint user of the vehicle in response to the request signal is received.

17. The information processing method according to claim 10, wherein the vehicle is provided with a battery that supplies electrical power for the communication function to operate and is charged using the power that is produced while the internal combustion engine is in operation, and the specified period of time is a period of time that is needed to charge the battery to a level equal to or higher than a threshold.

18. The information processing method according to claim 10, wherein the start command comprises a command for starting the internal combustion engine and causing an air conditioning system provided in the vehicle to operate.
